(19) United States
(12) Patent Application Publication
(10) Pub. No.: US 2002/0119851 A1
(43) Pub. Date: Aug. 29, 2002

(54) Pulley with microprofiled surface

(75) Inventor: Jorg Lukschandel, Kempten (DE)

Correspondence Address: COLLARD & ROE, P.C., 1077 Northern Boulevard, Roslyn, NY, 11576, US

(73) Assignee: WACKER-CHEMIE GmbH, Munchen (DE)

(21) Appl. No.: 09/998,088

(22) Filed: Nov. 30, 2001

(30) Foreign Application Priority Data
Dec. 21, 2000 (DE) 100 64 057.5

(51) Int. Cl. F16H 55/36

(52) U.S. Cl. 474/177; 474/184

(57) ABSTRACT

A pulley has a wear-resistant dispersion coating on its running surface. This pulley is produced by an electrodeposition coating process without an external current (chemical deposition), and followed by a heat-treatment.

### BACKGROUND OF THE INVENTION

1. Field of the Invention

The present invention relates to a pulley which has a wear-resistant dispersion coating on its surface.

2. The Prior Art

Pulleys are among the oldest mechanical devices used to transmit rotational movements. At first, only natural materials were available. Hence the “belts” were made from ropes or leather, and the pulleys were made from wood. It was found that applying pitch increased the friction between the belt and pulley.

In modern, stronger belt drives, metallic pulleys are almost exclusively used. Particularly in the case of flat belt drives, these pulleys are covered with rubber or the like or with coatings containing coarse hard-material particles in order to increase the friction.

High-speed belt drives are predominantly designed as V-belt drives. The pulleys generally consist of gray cast iron, and the belts are of multilayer structure with low-expansion fabric strips and covering layers made from elastomers.

Elastomers are therefore particularly advantageous as the surface of the belt. This is because the expansion slip which occurs during movement of the belt is to a very large extent absorbed by elastic deformation in the covering layer and less by actual slipping in the contact region with the pulley.

The Eytelwein equation applies to the slipping of the belt on the pulley:

F₁=F₂·e^{μα}

(cf. Niemann-Winter “Maschinenelemente” [Machine components], Vol. III, pp. 154 to 156, Springer Verlag, 1983).

In practice, the predetermined design configuration of the belt drive means that all the variables apart from the coefficient of friction μ can be regarded as constant. Therefore, the coefficient of friction is of considerable importance for the performance of a belt drive.

The pulleys for belt drives, particularly in engines, are generally mounted in a flying position on the associated shafts. This leads to a high, unavoidable bending load on the shaft in the bearing. As the rotational speed increases, considerable centrifugal forces act on the moving belt and have to be compensated for by belt-tensioning systems, in order to prevent the belt from slipping.

When new, the pulley typically has a surface roughness which is caused by metal-removing machining. The peak points of roughness are present in the resilient surface of the belt, and to a large extent prevent relative movement during the expansion slip phase. However, as the operating time increases, the belt surface becomes smoothed. This is clearly recognizable to a person skilled in the art of pulleys which have already been in operation through the shiny appearance of the pulley. As a result of this smoothing, the coefficient of friction μ drops, so that a high belt pretension is required in order to maintain reliable operation. Therefore, high-speed and high-performance belt drives have to be provided with reinforced bearings and high-strength belts.

As mentioned above, with given design and dynamic variables, it is only possible to influence the operation of the belt drive by means of the coefficient of friction. In the physical sense, it is only possible to speak of a coefficient of friction between the pulley surface and the belt once the wear-related smoothing of the pulley surface has taken place. Before this, gear-like engagement between the peaks of roughness on the pulley surface and the elastomer layer of the belt is the predominant factor, and this leads to higher frictional forces.

It would be highly advantageous for the surface topography of the pulley to be configured in such a way that a uniformly high coefficient of friction could be ensured not only when new but also throughout the entire operating life, without the belt being unacceptably affected. This would enable the required belt tension in a given arrangement to be reduced and the entire belt drive to be of more lightweight design. This would save costs, weight, drive energy and space.

### SUMMARY OF THE INVENTION

It is an object of the present invention to provide a pulley having this kind of surface topograph.

The above object is achieved by the present invention which provides a pulley which has a wear-resistant dispersion coating on its running surface. The running surface is that surface of the pulley which contacts the movement causing element such as a belt.

A dispersion coating comprising a dispersed substance and a matrix is distinguished by the fact that the dispersed substance is present in the form of a solid with a particle size. This particle size is smaller by a multiple than the layer thickness of the matrix. All previously known coatings of pulleys with particles are produced either by thermal spraying of powders (cf. Abstract of JP 52118157) or the application of coarse particles by means of an organic binder (cf. U.S. Pat. No. 3,498,817).

The dispersion coating has defined peaks of roughness in order to produce a positive microlock with conventional belt surfaces. This topography does not change even when worn, so that the coating does not cause any unacceptable damage to the belt.

The dispersion coating preferably contains a metal or a metal alloy as matrix.

It is particularly preferable to employ a nickel or a nickel alloy, as the matrix material.

The dispersed substance preferably comprises inorganic particles. It is preferable to use hard-material particles, as the dispersed substance.

The hard-material particles are preferably selected from the group consisting of the oxides, carbides, nitrides and diamond. The oxides are preferably the oxides of Al, Zr or Cr. The carbides are preferably the carbides of Si, Bi or Ti. The nitrides are preferably the nitrides of Si or hexagonal boron nitride.

The size of the particles dispersed in the coating plays a decisive and important role for the transmission of forces which can be achieved and the need to preserve the belt surface. The particles preferably have a mean diameter of less than 20 μm, particularly preferably of less than 5 μm. The particles particularly preferably have a mean diameter of 2 μm. The statistical range for a mean diameter of 15 μm is preferably 10 to 20 μm, while for a mean diameter of 5 μm this range is preferably 2 to 8 μm, and for a mean diameter of 2 μm this range is preferably 0.1 to 4 μm.

The layer thickness of the dispersion coating on the pulley is preferably greater by a multiple than the particle diameter of the dispersed phase.

The layer thickness of the dispersion coating is preferably 5 to 20 times, particularly preferably 10 to 15 times, greater than the particle diameter.

The particles preferably form from 15 to 30% by volume, preferably from 20 to 25% by volume, of the dispersion layer.

This ensures that even when wear to the dispersion coating progresses, new particles constantly emerge and project as roughness peaks out of the surface of the dispersion coating. Although a single-phase layer can likewise be deposited with a suitable surface structure in the new state, it is smoothed by wear and loses its effect. Therefore, it does not offer the benefits of a coating according to the invention.

The invention also relates to a belt drive comprising a pulley and a belt, wherein a pulley according to the invention is used as the pulley.

The invention also relates to the production of a pulley according to the invention. The pulleys according to the invention are preferably produced by coating a standard pulley by means of a coating process which is known per se. The dispersion coating (hard material/metal layer) is preferably produced by means of an electrodeposition process, e.g. by nickel plating without external current (chemical nickel plating). The joint deposition of metals and solid particles is in widespread use and known in electrodeposition technology. This applies in particular to the nickel/silicon carbide combination. Nickel is deposited either electrolytically or without external current (“chemically”) as a nickel-phosphorus alloy.

Electrolytic dispersion layers are generally remachined, since their growth does not follow the original contours and they often also have an unacceptable roughness. Although chemically deposited layers grow more slowly by an order of magnitude, they precisely reproduce even complicated forms of component and, in addition, can be hardened by heat treatment. There is no need for them to be remachined.

Therefore, the dispersion coating is preferably produced by deposition without external current (chemical deposition) of a nickel-phosphorus alloy with the incorporation of a suitable hard-material grain fraction.

First of all, preferably, a standard pulley which is used for the production of a pulley according to the invention is blasted, for example with glass beads. This occurs in the area of contact with the belt, in order to eliminate any effects of production.

There then follows, in a manner known per se, a dispersion coating by deposition without external current (chemical deposition) of a nickel-phosphorus alloy with the incorporation of a suitable hard-material grain fraction.

Then, the pulley which has been provided with the dispersion coating is preferably heat-treated in a manner known per se in order to achieve the maximum possible resistance to wear. This takes place, for example, by heating at 350° C. for 2 hours.

Then, loosely adhering particles are preferably removed by gentle blasting with glass beads.

### DETAILED DESCRIPTION OF PREFERRED EMBODIMENTS

Other objects and features of the present invention will become apparent from the following detailed description considered in connection with the accompanying Examples which disclose several embodiments of the present invention. It should be understood, however, that the Examples are designed for the purpose of illustration only and not as a definition of the limits of the invention. The following Examples serve to explain the invention further.

### EXAMPLE 1

### Production of a Pulley According to the Invention

A new pulley for a compressed-air supply unit on an agricultural tractor (cf. Example 4) was treated as follows:

Blasting with glass beads with a diameter of 40 to 80 μm under a blasting pressure of 2 bar in order to level the turning-tool marks in the contact surface or running surface between pulley and belt.

Mounting the pulley, with the mating surface for the compressor shaft being sealed.

Suspending the entire assembly in the conveyor system of an electrodeposition unit which is designed for chemical dispersion coating.

Carrying out the chemical pretreatment appropriate to the material gray cast iron by degreasing for 20 min at 80° C., pickling for 2 min in an H₂SO₄ pickling solution at 40° C. and activating for 2 min in acid mixture at 30° C., together with the intervening rinsing steps.

Dipping in a chemical nickel bath of type NL 65 (obtainable from Shipley, Stuttgart), in which 10 grams of silicon carbide powder with a mean particle size of 2 μm were dispersed per liter.

Deposition of the nickel-SiC dispersion layer over a period of 2 hours with an overall layer thickness of 27 μm.

Ultrasonic rinsing, removal of the pulley from the goods holder.

Heat treatment of the pulley for 2 hours at 350° C.

After cooling, mechanical removal of loosely adhering silicon carbide particles by blasting with glass beads at a blasting pressure of 0.8 bar.

### EXAMPLE 2

### Determining the Influence of the Particle Size in the Dispersion Coating

V-pulleys were coated with dispersion layers of different particle sizes in a similar manner to that described in Example 1 and were each subjected to endurance tests in order to determine the extent of damage to the belt. The contact surfaces of the pulleys were leveled by blasting with glass beads prior to the coating, as described in Example 1. This was done in order to eliminate the influence of any discrepancies brought about by the preceding metal-removing machining. On account of its simple availability, the dispersed substance selected was silicon carbide, and nickel deposited without external current was selected as the dispersion medium (matrix).

For the grain size of 1 μm, the concentration of the dispersed substance was 18% by volume, while for the other grain sizes the concentration of dispersed substance was 25±3% by volume.

The tests were carried out for 100 hours or until the belt was destroyed. After every 24 hours, the pulleys and belts were optically examined under 15 times magnification. The results are given in TABLE 1.

The damage levels given in that table mean:

For the pulley (P)
0 = unchanged
1 = slightly smoothed
2 = polished
3 = run down
4 = greatly run down
For the belt (B)
0 = unchanged
1 = smoothed
2 = roughened
3 = cracked, greatly roughened
4 = destroyed

TABLE 1
Compatibility of different particle sizes in
dispersion layers with belt surfaces

| Grain | Scatter | 24 hours | | 48 hours | | 72 hours | | 100 hours | |
|---|---|---|---|---|---|---|---|---|---|
| size | range | P | B | P | B | P | B | P | B |
| 1 μm | 0-2 μm | 1 | 0 | 2 | 0 | 2 | 1 | 2 | 1 |
| 2 μm | 1-4 μm | 1 | 0 | 1 | 0 | 1 | 0 | 1 | 0 |
| 4 μm | 2-6 μm | 0 | 0 | 0 | 1 | 1 | 2 | 1 | 3 |
| 8 μm | 5-12 μm | 0 | 3 | 0 | 4 | — | — | — | — |

For the further tests, only particles with a mean diameter of 2 μm were used.

### EXAMPLE 3

### Determining the Influence of the Particle Material

Grain sizes which corresponded to the silicon carbide with a mean grain size of 2 μm used in the first section were produced from commercially available hard-material powders by sedimentation. The hard materials were aluminum oxide (corundum) from the oxide group, silicon carbide and boron carbide from the carbide group, and diamond.

The coating took place as described in Example 1, with in each case one of the abovementioned grain fractions being used instead of the SiC grains referred to in that example.

The pulleys covered with the various hard-material layers were heat-treated for 2 hours at 350° C. in order to achieve the maximum possible wear resistance of the layers.

Loosely adhering particles were then removed by gentle blasting with glass beads with a diameter of 40 to 80 μm (commercially available) and under a pressure of 0.8 bar.

The pulleys were subjected to an endurance test with matching V-belts. At the start of the test and after 100, 250 and 500 hours, the contact surfaces of the pulleys and belts were optically assessed under 15 times magnification. In addition the coefficient of friction with a belt wrap of 120°was calculated from the drive force/output force ratio with the aid of the transformed Eytelwein equation as follows:

$$μ = ln ( \frac{{F}_{1}}{{F}_{2}} : α )$$

The results are given in TABLE 2. The damage levels are as indicated for TABLE 1.

TABLE 2
Compatibility and friction performance of various
hard materials in dispersion layers and belt surfaces

| Hard | | | | | | | | | | | | |
|---|---|---|---|---|---|---|---|---|---|---|---|---|
| material | New | | | 100 | | | 250 | | | 500 hours | | |
| 2 μm | P | B | μ | P | B | μ | P | B | μ | P | B | μ |
| Uncoated | 0 | 0 | 0.52 | 2 | 0 | 0.34 | 3 | 1 | 0.28* | 4 | 3 | 0.29* |
| Al₂O₃ | — | — | 0.61 | 1 | 1 | 0.58 | 1 | 1 | 0.56 | 2 | 2 | 0.54 |
| SiC | — | — | 0.65 | 1 | 1 | 0.62 | 1 | 1 | 0.60 | 2 | 2 | 0.58 |
| B₄C | — | — | 0.64 | 1 | 1 | 0.60 | 1 | 1 | 0.55 | 3 | 2 | 0.48 |
| Diamond | — | — | 0.72 | 0 | 1 | 0.70 | 0 | 2 | 0.71 | 0 | 3 | 0.69 |

*Whistling noises occurred

As can be seen from TABLE 2, dispersion layers generally lead to higher coefficients of friction. The significant drop in the coefficient of friction of an uncoated pulley (1st line) after even a short running time clearly demonstrates that in conventional belt drives the belt tension has to be selected at a very high level from the outset in order to ensure sufficient reliability for the required transmission of power. The greater slip in this case caused by lower friction also leads to the belt being heated to a greater extent, and this leads to cracks forming as the running time becomes longer.

By contrast, even after relatively long running times, dispersion-coated pulleys only loose their grip to a slight extent, without any unacceptable damage to the belt surface being observed. One exception is diamond as the dispersed substance which, although it achieves the highest coefficients of friction, caused more extensive damage to the belt during the tests. However, if there are particularly high demands imposed on the belt drive, while accepting a shorter service life of the belt, diamond could be the first choice as the dispersed substance.

The examples clearly demonstrate that pulleys with dispersion-coated running surfaces in accordance with the present invention represent an unexpectedly significant technical improvement. Belt drives which use pulleys of the invention can be of more lightweight design and save materials costs, weight and drive energy. In this way, the additional costs of the coating can at least be compensated for. In addition, the occurrence of whistling and squeaking noises, which are considered to be extremely disruptive in particular in the automotive industry, is reliably prevented.

### EXAMPLE 4

### Use of a Pulley According to the Invention

To test the performance of a belt drive with dispersion-coated pulleys in the field under conditions which are as unfavorable as possible, the drive for a compressed-air supply installation on an agricultural tractor was selected as a practical example. With this drive, whistling noises caused by the belt slipping regularly occurred shortly before the final pressure of 11.5 bar was reached. Agricultural machines are typically exposed to high levels of dirt and therefore to increased wear, and consequently the selected example is highly relevant.

The pulley which is positioned on the compressed-air compressor is driven by the crankshaft via two V-belts. The belt tension is usually corrected after approximately 100 operating hours, yet the abovementioned whistling noises still regularly occur. A new pulley was procured and was treated as described in Example 1. The pulley which had been treated in this way was mounted on the shaft of the compressed-air compressor on a tractor of type FENDT 312 LSA. Two new V-belts were fitted and were tensioned in accordance with the operating instructions. The tractor was operated in the customary way, and the running surfaces of the pulley and belt were optically assessed and the belt tension checked approximately every 200 operating hours.

There were no whistling noises throughout the entire observation period of 1 040 hours. The belts and pulleys did not show any signs of wear. There was no need to re-tension the belts throughout the entire period.

Accordingly, while a few embodiments of the present invention have been shown and described, it is to be understood that many changes and modifications may be made thereunto without departing from the spirit and scope of the invention as defined in the appended claims.

What is claimed is:

1. A pulley which has a running surface; and
a wear-resistant dispersion coating on said running surface.

2. The pulley as claimed in claim 1,
wherein the running surface has a topograph;
wherein the dispersion coating has defined roughness peaks in order to produce a positive microlock with a belt surface and even when worn this topography does not change, so that the coating does not cause any unacceptable damage to a belt.

3. The pulley as claimed in claim 1,
wherein the dispersion coating contains a matrix selected from the group consisting of a metal and a metal alloy.

4. The pulley as claimed in claim 1,
wherein the dispersion coating contains a dispersed substance which is selected from the group consisting of inorganic particles, and hard-material particles.

5. The pulley as claimed in claim 4,
wherein the particles have a mean diameter of less than 20 μm.

6. The pulley as claimed in claim 5,
wherein the particles have a mean diameter of 2 μm.

7. The pulley as claimed in claim 5,
wherein layer thickness of the dispersion coating is 5 to 20 times greater than the particle diameter.

8. The pulley as claimed in claim 7,
wherein the layer thickness of the dispersion coating is 10 to 15 times greater than the particle diameter.

9. A process for producing a pulley comprising
providing a pulley; and
coating a running surface of the pulley by an electrodeposition coating process to produce a wear-resistant dispersion coating on said running surface.

10. The process as claimed in claim 9,
wherein the electrodeposition coating process used is a deposition without external current (chemical deposition) of a nickel-phosphorus alloy with a corresponding incorporation of a suitable hard-material grain fraction.

11. The process as claimed in claim 10, comprising
heat treating the pulley which has been provided with the dispersion coating in order to achieve a maximum possible wear resistance.

12. A belt drive comprising
a pulley and a belt, wherein the pulley is the pulley as claimed in claim 1.
